(19) United States
(12) Patent Application Publication
(10) Pub. No.: US 2020/0320492 A1
(43) Pub. Date: Oct. 8, 2020

(54) BILATERAL PAYMENT AND FUNDING OPTIMIZATION SYSTEMS AND METHODS

(71) Applicant: SwapAgent Limited, London (GB)

(72) Inventor: Bud F. Novin, New York, NY (US)

(21) Appl. No.: 16/376,443

(22) Filed: Apr. 5, 2019

(51) Int. Cl. G06Q 20/10; G06F 17/50

(52) U.S. Cl. CPC G06Q 20/10; G06F 17/5009

(57) ABSTRACT

Methods, systems, and computer program products are provided for optimizing funding and bilateral payments in settlement systems. Using the methods taught herein, a settlement agent may request significantly less funding from member institutions on a daily basis to accomplish the same payment tasks currently being performed. The settlement agent determines the bilateral net amount between each pair of participants, calculates the aggregate net amount for each participant, and then requests an amount of funding based on these calculations. Using the requested funding, the settlement agent then calculates and instructs a single concentration bank to perform a series of transactions that, when performed in order, provide a complete set of bilateral transactions between each institution to settle accounts.

### BACKGROUND

### I. Field

Example aspects of the present invention generally relate to bilateral payment systems between financial organizations, and more particularly to systems and methods for optimizing bilateral payments between counterparties, such as financial institutions, by automatically lowering debt and funding costs associated with current payment methods.

### II. Related Art

Over the course of a business day millions of financial asset transactions, valued in the trillions of dollars, are conducted between sellers and purchasers. Financial asset classes include, but are not limited, to commodities, securities, exchange traded derivatives, credit default swaps, energy contracts, freight derivatives, interest rate swaps, foreign exchange, loans, margin, bonds, and repos, and the financial groups that typically perform such transactions include banks, investment banks, broker dealers, commodity houses, investment funds, and the like (each such financial group member is referred to herein as a financial organization).

Following the execution of transactions, and/or the valuation of portfolios of assets, such as bilateral OTC derivatives, financial institutions must settle their accounts with one another each day. In order to do so, they must perform and agree valuation, instruct their bank to handle the movement of funds, confirm delivery or receipt, update their books and records, and various other operations, reconciliations, and compliance processes. Many of these settlements are required to occur on the day, and not being performed could cause breach of contract, reputational damage, and financial damage. ,This settlement of accounts between financial organizations requires that every financial organization settle with every other financial organization with which they do business in a relatively short amount of time, as the window in which each currency market is open and able to deliver cash is limited. Further, the amount of time it takes for bank to deliver cash and settle those funds into the account of a banking client can take hours, if not the entire day. Settlement requires that each financial organization balance its accounts with each other financial organization with whom it has done business. That means paying its debts and collecting its receivables. For example, Financial Organization A and Financial Organization B may have entered on the order of hundreds, thousands, or more transaction contracts on a given day with the result that one may owe the other some net amount. For example, if, after a day of business, the net result of 10,000 transactions is that Financial Organization A owes Financial Organization B 5 million U.S. Dollars (USD). Rather than perform 10,000 individual transfers between the two, Financial Organization A would settle accounts by paying 5 million USD to Financial Organization B.

It should be noted that settlement (or payment) is typically done on a per-currency basis, and at times related to only specific products or asset classes. Such that, for example, Financial Organization A may owe Financial Organization B 5 million EUR, while Financial Organization B may owe Financial Organization A 3 million USD. Financial Organizations A and B would typically resolve these debts separately, rather than attempt to consolidate through some form of currency exchange. Additionally, Financial Organization B may owe Financial Organization A 3 million EUR, for a separate business line, and for which a separate payment will be made, without regard for the offsetting 5 million for which netting may not be legally or operationally feasible. Thus, Financial Organizations A and B may settle several times per day, often more than once for each currency in which trades were transacted.

Financial organizations frequently work through an intermediary, such as a clearing house, to facilitate settlement, where an asset is able to be cleared. However, most of the payments making up the cash flows between the various financial organizations are not related to a clearing house and occur through so-called settlement banks. In banking and finance, clearing describes the procedure by which a third party acts as an intermediary and assumes the role of buyer and seller in the transaction and manages all the valuations, determinations, and payment settlements from the time of submission until the termination or expiration of the transaction. This facilitates the conversion of the promise of payment into the actual movement of money from one financial organization's account to another. A clearing house typically sits in the middle of a trade assuming the counterparty risk involved when two parties trade, guaranteeing the settlement of the trade. To mitigate the centralized risks involved, the clearing house imposes certain minimum requirements on its members and collects initial and variation margin (or collateral) from them for trades that have been executed.

Because a clearing house has inserted itself into the middle of every transaction, it has assumed all counterparty risk. The clearing house acts as principle to each transaction, with the novation of each leg of the trade to a clearing house which becomes seller to every buyer and buyer to every seller. As such, the clearing house sits in the middle of all trades, allowing for all payments in a given currency to the clearing house to be netted, even though a member of the clearing house may have transacted with various other members. Thus, if Member A owes 10 million USD to Member B and 20 million USD to Member C, but is owed 15 million USD by Member D, then the clearing house need only collect 15 million USD (plus margin, fees, etc.) from Member A for settlement. For this service (and to insure itself against loss), a clearing house has strict requirements and collects guarantee funds and margin. Furthermore, clearing houses cannot or will not participate in certain products it deems too risky. Additionally, because of the cost of clearing, where not mandated by law, some financial institutions will choose not to use a clearing house even though one might he available. As such, for various reasons, certain obligations which must be paid between two counterparties without the intervention of a clearing house arise daily. Used herein, the term cash flow refers to any payment between two parties, margin owed from one party to another, and any other desire or requirement to deliver cash between two parties. Clearing houses work well with traditional transactions, such as sales of goods or derivatives. Cleating houses do not traditionally participate in other forms of cash flow, such as simple debt repayment or the like. Clearing houses provide other services that financial institutions sometimes find convenient as well, such as valuation, middle office, and warehousing.

An alternative to a clearing house would be a settlement agent that does not assume the counterparty risk between participants, but instead acts as an agent for the participants to perform bilateral payments, without novation of any trade to a third party clearing house. An example of such a settlement agent is the SwapAgent service provided by SwapAgent Limited, a subsidiary of LCH Group Holdings Limited. This way, rather than negotiate and make wiring arrangements with tens or hundreds of other institutions, a financial organization allows the settlement agent to handle the actual cash flows, but without the settlement agent acting as a counterparty. Each financial organization that participates in settlement through a settlement agent must still consider and separately pay each counterparty to which it owes money, as the trades are still bilateral and the payments are contractually obligated between counterparts. Thus, if Financial Organization A owes 5 million USD to Financial Organization B, 12 million USD to Financial Organization C, and 3 million USD to Financial Organization D, then Financial Organization A must provide a total of 20 million USD to the settlement agent to cover its payments, even if it expects to receive money from Financial Organizations E, F, and G. This requirement to fund all debts without regard for expected payments can be costly, operationally burdensome, capital intensive, and harm liquidity. Frequently, financial organizations are required to hold a buffer against, or take on short term debt to cover these payments, even when expecting a positive net payment for the day. This short term debt costs the financial organization money and can reduce its expected profits.

A settlement agent does not function like a clearing house, which can simply net the expected cash flows for all its members together and only require payments from those participants owing money to the clearing house after such netting and move those funds to those expecting a net positive amount for the day. Clearing houses are able to effect such netting across all members because it is a party to every transaction. It is not feasible for a settlement agent to do this as it is not a principal to any transaction. Additionally, a clearing house records and allocates each payment flow, which is critical to evidence the discharge of the contractual payment obligations of itself and its members. Even outside a clearing house, contractual counterparties will require the recording of payment flows in order to evidence the full discharge of bilateral contractual payment obligations.

What is needed, then, is a technological solution that reduces the debt burden on financial organizations in the settlement/payment process through a settlement agent, but still allows full, recordable, bilateral payments between each participant and its counterpart, regardless of the genesis of the cash flow. One potential but unexplored method to accomplish this goal is to break the transactions into multiple parts. Breaking a transaction into multiple payments and performing those payments in a random order may lower initial funding requirements, but such lowering would not be consistent and, for maximum benefit, may require many times more transactions. What is needed, then, is a method to perform these transactions in an ordered fashion so that fewer transactions and less initial funding is needed to accomplish the full bilateral payment of all bilateral debts by all counterparties. Such ordering would save both processing power and bandwidth in performing the transactions, which may also reduce in quantity. There is currently no known technology for providing such lowered up-front burdens while also maintaining the legal bilateral payment relationship between counterparties.

### SUMMARY

The foregoing and other limitations are overcome by a system, method, and non-transitory computer medium storing instructions for automatically performing bilateral payments among a plurality of participants.

In an example, a method is provided for automatically performing bilateral payments among a plurality of participants. The method includes; determining, for each participant, the bilateral net amount owed between that participant and each other participant; determining, for each participant, the aggregate net amount by summing all bilateral net amounts for the participant; requesting each participant provide an amount of money no less than the aggregate net amount owed by that participant to all other participants, calculating an ordered series of one or more bilateral transactions between each participant and each other participant that satisfies the bilateral net amount between each pair of participants, wherein at no time does the net amount paid by a participant to other participants minus the amount received by that participant from other participants exceed the amount provided by that participant; and performing the calculated ordered series of transactions by transferring money between bank accounts wherein each transaction is separately recorded, timestamped and effected.

In another example, there is provided a system for automatically performing bilateral payments among a plurality of participants. The system includes a computer-readable memory storing executable instructions and one or more processors in communication with the computer-readable memory. The processors are programmed by the executable instructions to at least perform the steps of determining, for each participant, the bilateral net amount owed between that participant and each other participant; determining, for each participant, the aggregate net amount by summing all bilateral net amounts for the participant; requesting each participant to provide an amount of money no less than the aggregate net amount owed by that participant to all other participants; calculating an ordered series of one or more bilateral transactions between each participant and each other participant that satisfies the bilateral net amount between each pair of participants, wherein at no time does the net amount paid by a participant to other participants minus the amount received by that participant from other participants exceed the amount provided by that participant; and performing the calculated ordered series of transactions by transferring money between bank accounts wherein each transaction is separately recorded, timestamped and effected.

In another example, there is provided a computer readable medium storing executable instructions, the instructions for automatically performing bilateral payments among a plurality of participants include determining, for each participant, the bilateral net amount owed between that participant and each other participant; determining, for each participant, the aggregate net amount by summing all bilateral net amounts for the participant; requesting each participant to provide an amount of money no less than the aggregate net amount owed by that participant to all other participants; calculating an ordered series of one or more bilateral transactions between each participant and each other participant that satisfies the bilateral net amount between each pair of participants, wherein at no time does the net amount paid by a participant to other participants minus the amount received by that participant from other participants exceed the amount provided by that participant; and performing the calculated ordered series of transactions by transferring money between bank accounts wherein each transaction is separately recorded, timestamped and effected.

### BRIEF DESCRIPTION OF THE DRAWINGS

The features and advantages of the example embodiments of the invention presented herein will become more apparent from the detailed description set forth below when taken in conjunction with the following drawings.

FIG. 1 is a block diagram of the environment for performing bilateral payments between a plurality of participants, a settlement bank, and a settlement agent in accordance with an example embodiment of the present invention.

FIG. 2 is a block diagram of the environment for performing bilateral payments between a plurality of participants, a settlement bank, a concentration bank, and a settlement agent in accordance with an example embodiment of the present invention.

FIG. 3 depicts a block diagraph of exemplary components of the bilateral payment processor in accordance with an example embodiment of the present invention.

FIG. 4 depicts an example process for performing optimized bilateral payments among a plurality of participants in accordance with an example embodiment of the present invention.

FIG. 5 depicts an example funding situation in which the settlement agent must request funding greater than each participant's aggregate net amount.

FIG. 6 depicts an example funding scenario for five members.

FIG. 7 is a block diagram of an exemplary hardware system useful for implementing the present invention in accordance with an example embodiment of the present invention.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Generally speaking, example aspects of the present invention provide a bilateral payments processor for performing bilateral payment processing for a plurality of participants. The bilateral payments processor accomplishes this by learning, from each client/participant of an agent how much that participant owes to or is owed by each of that participant's counterparties in cash in a given currency. The bilateral payments processor then calculates an aggregate net amount owed or due to each participant from all other participants and calculates an ordered series of transactions. An ordered series of transactions refers to a plurality of transactions that, for reasons described herein, must be performed in a predetermined order. In an example embodiment, each participant is required to initially provide less than the gross amount it owes, based on an order which will be sufficient to make all such payments without its balance going negative, so long as it receives some bilateral amounts prior to paying all bilateral amounts owed. The amount of funding required by each participant may be no less than the aggregate net amount owed by the participant to all other participants with whom it has transacted cash flow. This funding requirement represents the amount necessary for the bilateral payment processor to provide complete, bilateral payments between all participants. In ideal circumstances, the bilateral payment processor may calculate a set of transactions that allows each participant to provide only its aggregate net amount owed. Determining a series of transactions to effect the payments with each participant providing only its aggregate net owed amount may, in some circumstances, prove difficult or impossible for a variety of reasons, such as where total funding by all participants would equal zero. As computing power increases, the more effectively the system may lower the required funding amount. In practice, however, financial institutions may be asked to account for potential delays in funding by other participants. For this reason, the bilateral payments processor may ask a participant to provide its aggregate net amount, less some number of gains, unless the participant's aggregate net amount is significantly positive (meaning the participant anticipates receiving significantly more money than it owes, wherein the participant will provide zero) or the participant is owed nothing by any other participant, or is owed money but an order will not permit it to receive any bilateral amounts owed before paying (wherein the participant will need to fund the entire amount owed to all other participants, similar to previous models). This required funding amount may be communicated to each participant via a network interface between the bilateral payments processor at the clearing house and each participant's computer system.

### Environment for Automatically Performing Bilateral Payments Among a Plurality of Participants

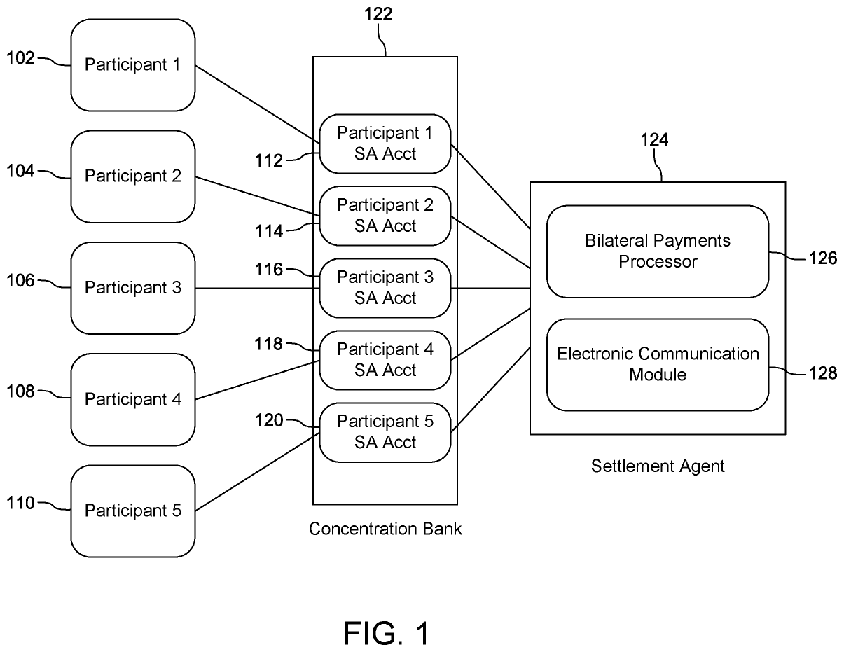

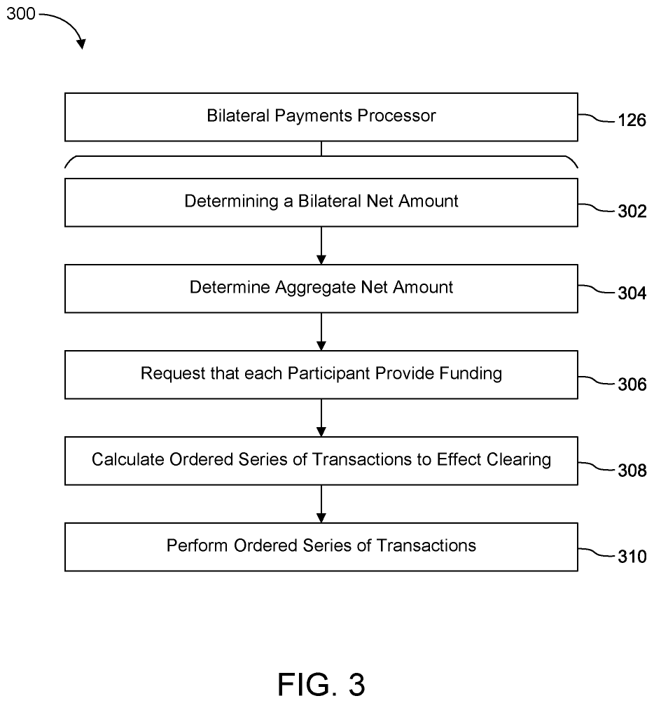

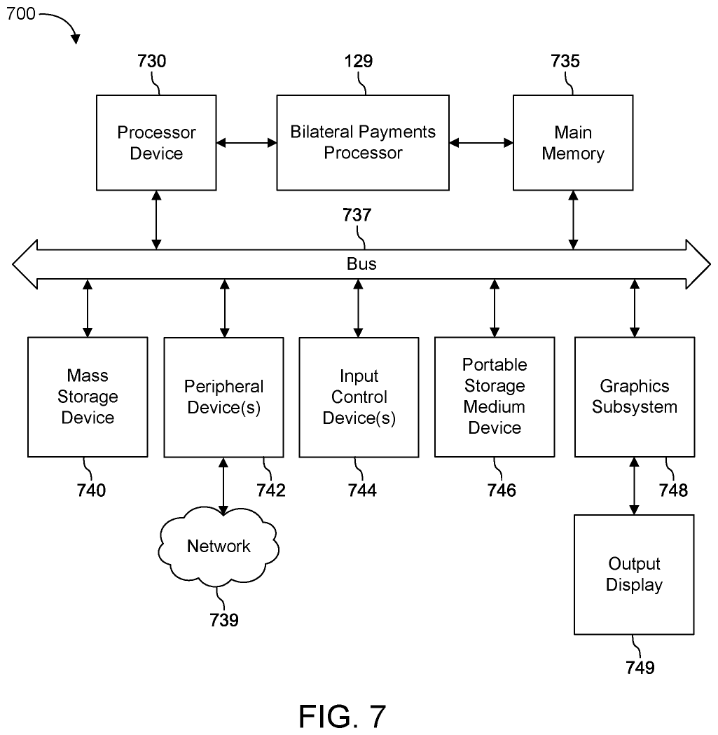

FIG. 1 illustrates an example of an environment for the interactions between participants 102-110, the settlement agent 124 and the concentration bank 122 for performing bilateral payments among the plurality of participants. Within the settlement agent 124 may be a bilateral payments processor 126 for calculating and performing the cash transactions to settle accounts between participants and an electronic communication module 128 for communicating information or instructions to financial organizations such as the participants 102-110 and concentration bank 122. Hardware and software components contained within the settlement agent 124 are discussed in more detail, below, in relation to FIGS. 3 and 7. Participant 1 102, Participant 2 104, Participant 3 106, Participant 4 108, and Participant 5 110 each may own a participant-settlement agent account 112-120, correspondingly, at a single concentration bank 122. Each participant-settlement agent account may be opened and controlled by the settlement agent 124 on behalf of the corresponding individual participant by communicating instructions to the concentration bank 122 via the electronic communication module 128. For example, the settlement agent 124 may open the Participant 1 settlement agent account 112 at the concentration bank 122 on behalf of Participant 1 102. The use of a single concentration bank 122 allows the settlement agent 124 to perform multiple transactions within the concentration bank 122, moving money between accounts at the concentration bank 122, in a short period of time. It should be clear that a group of participants within a settlement agent group may contain any number of financial organizations, and that five participants are depicted herein for ease of understanding and as an example. Typical settlement agents process cash flows associated with hundreds or thousands of financial organizations, leading to operations of significantly greater complexity than the simple examples depicted in FIGS. 1-5.

During the calculation process, the bilateral payments processor 126 calculates a funding amount that each Participant 102-110 needs in order to make all outstanding bilateral cash payments owed. The bilateral payments processor 126 transmits that funding amount to each of the participants 102-110. The bilateral payments processor 126 may transmit the funding amount via the electronic communication module 128 of the settlement agent 124. Upon receiving from the bilateral payments processor 126 its individual funding amount, each participant 102-110 may provide funding via its individual participant-settlement agent account 112-120. This transfer of funds may occur between each participant's individual bank and the concentration bank 122 via wire transfer or other computerized means for transferring funds between financial institutions. The bilateral payments processor 126, in turn, calculates an ordered series of bilateral payments between the participants. In an example embodiment, the ordered series of bilateral payments between the participants is such that, when performed will settle the accounts between each of the participants without causing any participant to pay a net amount more than the amount calculated for funding and provided by the participant. That is to say that at no time does the net amount paid by the participant to other participants and received by the participant from other participants exceed the amount provided by that participant. The bilateral payments processor 126, in turn, performs the ordered series of cash flows to transfer funds between the participant-settlement agent accounts 112-120. The ordered series of payments may be effectuated by transmitting an instruction from the bilateral payments processor 126 via the electronic communication module 128 of the settlement agent 124 to the computer system of the concentration bank 122, the instruction containing sufficient information to cause the concentration bank 122 to transfer funds between participant-settlement agent accounts—thus generating one or more bilateral payments between participants. After the completion of the ordered series of payments, the amount remaining in the participant-settlement agent accounts 112-120 of each Participant 102-110 at the concentration bank 122 will be the original balance of funding+/−the expected net amount. This amount will be the expected positive net amount if the participant's total net amount was positive or if the requested funding amount was greater than the participant's net liability for the day. Alternatively, the balance in the participant-settlement agent account 112-120 may be zero if the participant's funding requirement was equal to its total net liability for the day.

### Environment for Automatically Performing Bilateral Payments Among a Plurality of Participants, Including the Use of Concentration Accounts

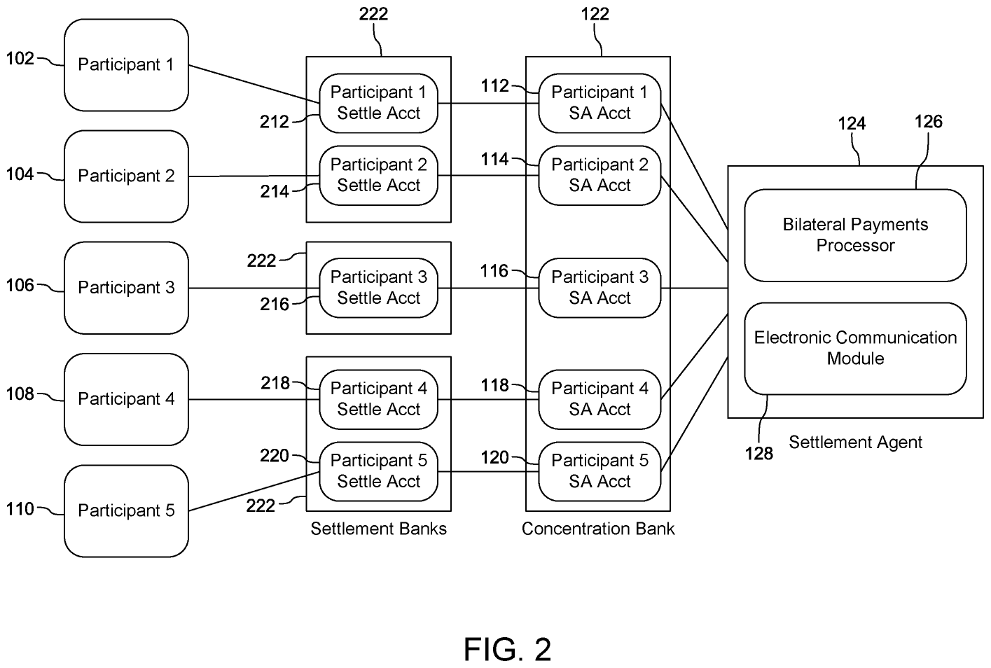

FIG. 2 illustrates an alternative embodiment, where the settlement agent 124 may open and operate two accounts owned by and for the benefit of participants 102-110. Specifically, the settlement agent 124 may open participant-settlement agent accounts 112-120 at a concentration bank 122 into which each participant will provide funding by transmitting instructions via the electronic communication module 128 to the concentration bank 122. These accounts may be known, generically, as concentration accounts. The settlement agent 124 may also open participant-settlement accounts 212-220 by transmitting instructions via the electronic communication module 128 to one or more settlement banks 222. A participant-settlement account is an account that is owned by and operated for the benefit of each Participant 1-5 102-110. These accounts may be known, generically, as simply “settlement accounts”. These settlement accounts 212-220 may also be opened by participants 102-110, themselves. To provide funding, each participant 1-5 102-110 may transmit instructions to transfer money from its respective participant-settlement account 212-220 to the appropriate participant-settlement agent account 112-120. The bilateral payments processor 126 may then perform the ordered series of cash payments between the participant-settlement agent accounts 112-120. The ordered series of cash flows may be effectuated by transmitting instructions from the bilateral payments processor 126 via the electronic communication module 128 at the settlement agent 124 to the computer system of the concentration bank 122, the instruction containing sufficient information to cause the concentration bank 122 to transfer funds between participant-settlement agent accounts 112-120—thus generating one or more bilateral payments between participants. After performing the ordered series of payments, the settlement agent 124 may instruct the transfer of any remaining balance from the participant-settlement agent accounts 112-120 back to the appropriate participant-settlement account 212-220 for retrieval by the participants 102-110.

### Process for Performing Bilateral Payments

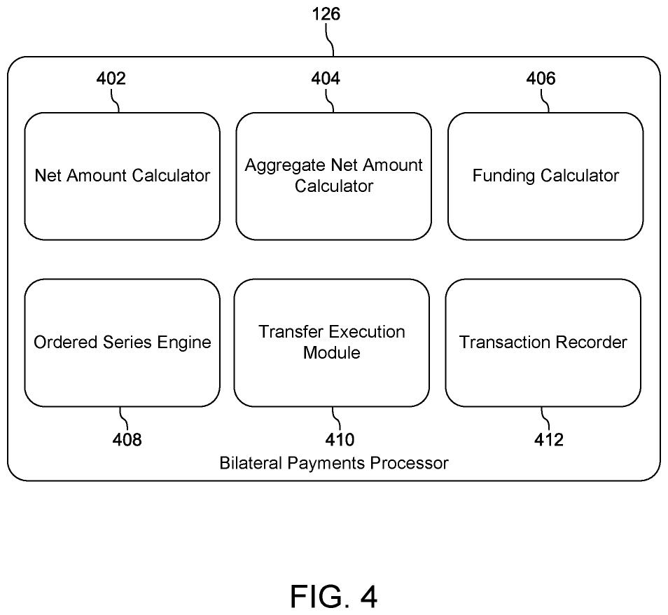

FIG. 3 illustrates a process 300 for performing bilateral payments among a plurality of participants in accordance with an example embodiment. The process is performed by various components at the settlement agent 124, such as the bilateral payments processor 126 and the systems or components therein, described in more detail with relation to FIGS. 4, and 7, below. The process begins at step 302 by determining, for each participant, a bilateral net amount owed between that participant and each other participant. This amount reflects the net value of cash flows to be paid or received between the two participants on a given day. This amount may be calculated by the bilateral payments processor 126 or may be received by the bilateral payments processor 126 from the participant or other source. In an example embodiment, step 302 is performed by a net amount calculator 402 component of the bilateral payments processor 126, shown in FIG. 4.

The two participants, for example Participants 1 and 2 102-104, may have conducted hundreds or thousands of transactions in the previous day. Some transactions involve Participant 1 102 owing money to Participant 2 104 and other transactions, vice versa. The net amount is simply the sum of all these transactions. So, for example, across hundreds or thousands of transactions, Participant 2 may ultimately owe 12 million USD to Participant 1.

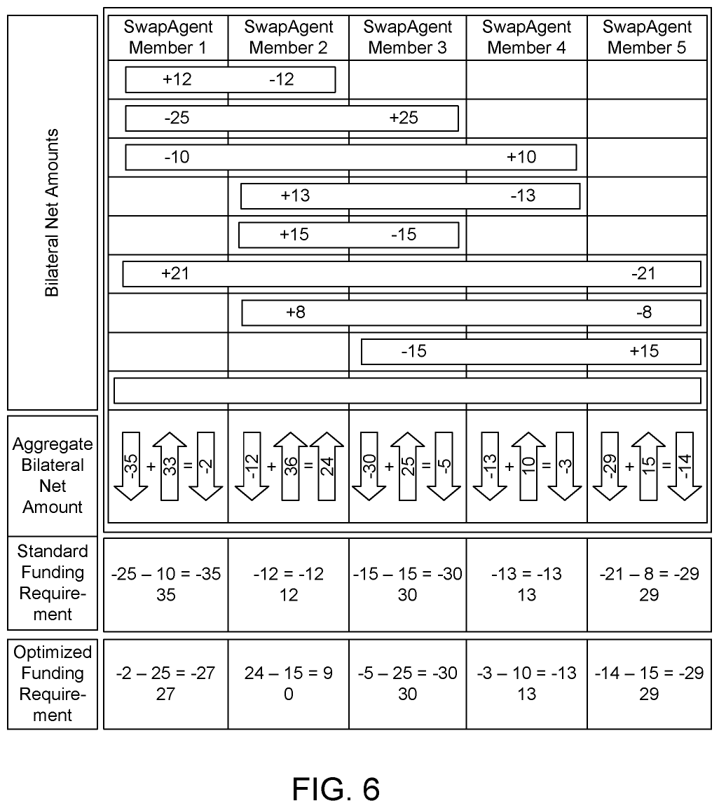

The bilateral payments processor 126 may then, in step 304, determine the aggregate net amount owed to each participant by summing all bilateral net amounts involving that participant. In an alternative embodiment, the bilateral payments processor 126 may then, in step 304, determine the aggregate net amount owed by each participant by summing all bilateral net amounts involving that participant. For example, if Participant 1 is owed 12 million USD by Participant 2 and 21 million USD by Participant 5, while owing 25 million USD to Participant 3 and 10 million USD to Participant 4, then Participant 1 will have an aggregate net amount of −2 million USD. FIG. 6 provides an example illustration of the computations involved in determining optimized funding requirements, standard funding requirements, aggregate bilateral net amounts, and net amounts. In an example embodiment, step 304 is performed by an aggregate net calculator 404 (shown in FIG. 4) of the bilateral payments processor 126, which is constructed to determine the aggregate net amount owed to (or by) each participant by summing all net amounts.

The bilateral payments processor 126 may then, in step 306, send a request message to each participant, requesting that that participant provide a coverage amount of funding to cover its debts. The funding amount requested may not be less than the participant's aggregate net amount, because any amount less than the aggregate net amount would fail to cover the participant's debts. In an example embodiment, step 306 is performed by a funding calculator 406 of the bilateral payments processor 126, which is constructed to calculate the necessary funding amount. The request message may be sent via the electronic communication module 128 of the settlement agent 124.

The funding amount requested may be any value between zero, if the participant's aggregate net amount is zero or higher, up to and including the sum of the participant's total outstanding debts, irrespective of any money owed to the participant. In an embodiment, the funding amount requested may be the aggregate net amount or zero, whichever is lower. In another embodiment, the funding amount requested may be the aggregate net amount minus the largest single amount the participant expects to receive from another participant (or zero, if the calculated amount is still above zero). In another embodiment, the funding amount may be equal to the participant's aggregate net amount minus the n largest, positive bilateral net amounts owed to that participant by one or more other participants, where n is an integer. Thus, the funding amount may be equal to the participant's aggregate net amount minus the largest, two largest, three largest, or n largest expected payments from other participants. In yet another embodiment, the amount requested may be the aggregate net amount minus a pre-calculated safety amount (or zero, if the calculated amount is still above zero).

In an embodiment, the requested coverage amount of funding may be provided by the participants into participant-settlement agent accounts 112-120, described above. In another embodiment, the funding amount may be moved from each participant-settlement account 212-220 into participant-settlement agent accounts 112-120.

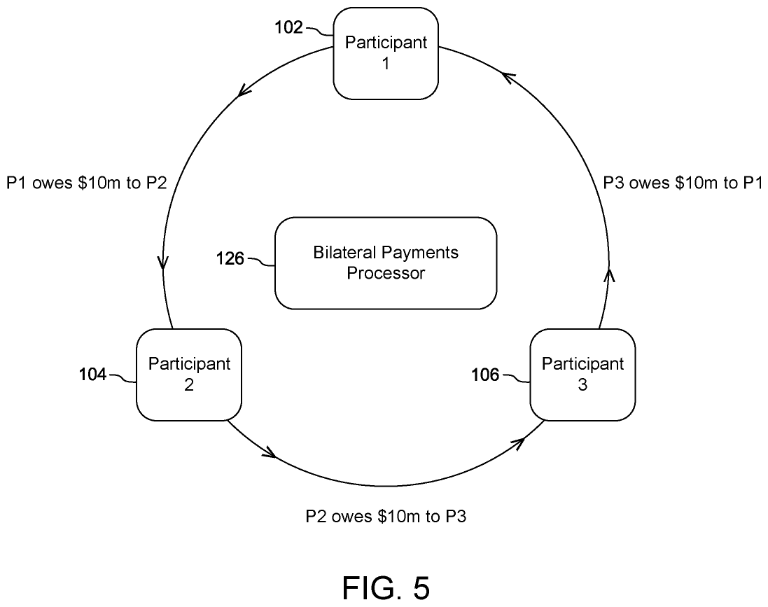

The bilateral payments processor 126 then, in step 308, calculates an ordered series of bilateral transactions between each of the participants to transfer the appropriate bilateral net amount between each pair of participants. This calculation may require multiple transactions between each participant until the full bilateral net amount is satisfied. For example, if Participant 2 owes 12 million USD to Participant 1 and is owed 8 million USD by Participant 5, 15 million US by Participant 3, and 13 million USD by Participant 4, the bilateral payments processor 126 may determine that Participant 2 need provide no funding. (This example is shown in FIG. 5) The bilateral payments processor 126 may then transfer 8 million USD from Participant 5's account to Participant 2, then provide that 8 million USD to Participant 1. It may later transfer 13 million USD from Participant 4 (who had received 10 million USD from Participant 1) to Participant 2. The settlement agent could use 4 million of the received funds to pay the remainder of the amount owed to Participant 1. In an example embodiment, step 308 is performed by an ordered series engine 408 of the bilateral payments processor 126 (shown in FIG. 4), which is constructed to calculate the ordered series of transactions between each of the participants resulting in the transfer of the appropriate bilateral amount between each pair of participants in one or more transactions.

The series of transactions is ordered in that, as described above, the order of performance is relevant. At no moment in time will any participant pay out more than the sum of its funding and the amounts it has so far received, at that time. In other words, the order of payments ensures that a participant's account balance will not drop below zero.

Calculating the ordered series of transactions is a significant computational problem. The system may manipulate both the order and size of each payment to provide an optimal outcome. The series of transactions may be optimized for several factors: lowering funding requirements, minimizing number of transactions, or other factors as a person of ordinary skill may desire. Optimizing for a minimal number of payments while providing the benefits herein described allows for more efficient computer use in that performing fewer transactions requires less bandwidth and processing by the devices at both the settlement agent 104 and concentration bank 122. Furthermore, the system described herein optimizes the use of national payment systems, such as Fedwire, by performing more intrabank transfers at the concentration bank and significantly reducing the number of interbank transfers requiring use of a national payment system. Depending on the starting parameters of funding requirements and aggregate net amounts among all participants, it may be more or less difficult to effect the complete payment in a reasonable number of transactions. For example, if a large number of participants all have large bilateral net amounts (meaning they all owe each other large sums of money) but every participant's aggregate net amount is low (meaning that each participant is roughly even for the day, and that the large debts are balanced by equally large receivables) then, if the system only requires minimal funding, it may take a large number of transactions to pay off each participant's debts to every other participant. In this scenario, calculating such a series of transactions is considered NP-Hard and similar to the classic “Traveling Salesman Problem” in computer science, but complicated by precedence requirements, so represents a traveling salesman problem of the sequential ordering variety.

Like other NP-Hard problems, a system may use heuristic systems to provide a good-but-not-perfect series of transactions. Providing the exact, minimal number of transactions is not necessary, so long as the system can perform all the steps within a reasonable amount of time such that other businesses at the participating financial organizations are not delayed, waiting for payment to finish. One method of generating such a good-but-not-perfect series is using a Monte Carlo method using repeated random testing to determine a reasonably minimal set of transactions to move the correct amount of money between all participants. Other methods for generating a reasonable series of transactions may include depth search algorithms, machine learning or other methods now known or future developed. Increased computer efficiency will obviously provide better results, both in allowing better calculation of optimized ordered series of transactions and also in allowing the system to perform more transactions in the same reasonable amount of time. In this way, the method benefits doubly from gains in computational power.

Finally, in step 310, the bilateral payments processor 126 performs the previously-calculated ordered series of transactions. It may do so by sending instructions to the concentration bank 122 via the electronic communication module 128, each instruction containing sufficient information to direct a transfer between participant-settlement agent accounts 112-120 at the concentration bank 122. After performing the transactions at the concentration bank 122, the bilateral payments processor 126 may move any remaining funds from the participant-settlement agent accounts 112-120 to the participant-settlement accounts 212-220 for access by the participants, by sending instructions from the bilateral payments processor 126 to the concentration bank 222 via the electronic communication module 128. In an example embodiment, step 310 is performed by a transfer execution module 410 of the bilateral payments processor 126 (shown in FIG. 4), which is constructed to instruct the transfers of funds, between accounts belonging to and operated on behalf of the participants, at a concentration bank.

In all cases, while performing the ordered series of transactions, each transaction is separately recorded as a bilateral transaction between the two participants. Each transaction is also timestamped within the record to provide proof that the transactions were performed in the correct order. In this way, each transaction is, itself, separately effected. In an example embodiment, this recording of each transaction is performed by a transaction recorder component 412 of the bilateral payments processor 126 (showing in FIG. 4).

### Example Implementation of a Bilateral Payments Processor

FIG. 4 is a block diagraph of exemplary components of the bilateral payments processor 126 in accordance with an example embodiment of the invention.

The net amount calculator 402 may calculate the net amount owed by a participant to another participant based on all cash flows performed between the participants. Alternatively, the net amount calculator 402 may calculate the net amount owed to the participant by another participant, based on all cash flows performed between the participants. This process is described in more detail, above, in relation to FIG. 3.

The aggregate net calculator 404 may calculate the aggregate net amount owed by a participant across all other participants by summing the value of all calculated net amounts between a participant and every other participant. This process is described in more detail, above, in relation to FIG. 3.

The funding calculator 406 may calculate the amount of funding required by a participant in order to pay all other participants. This process is described in more detail, above, in relation to FIG. 3.

The ordered series engine 408 may calculate the ordered series of transactions necessary to process all owed amounts between all participants. The ordered series engine 408 may calculate the ordered series in various ways, discussed in more detail, above, in relation to FIG. 3.

The transfer execution module 410 may perform the ordered series of transactions calculated by the ordered series engine 408, as described in more detail above, in relation to FIG. 3.

For each bilateral transaction executed by the transfer execution module 410, the transaction recorder may record the details of the bilateral transaction so that each transaction may be audited, unwound, or otherwise reviewed. This process is described in more detail, above, in relation to FIG. 3.

### Example Environments for Settlement

FIG. 5 illustrates an example of a settlement environment in which the bilateral payments processor 126 may not simply request that each Participant 102-106 provide funding equal to its aggregate net amount. In this example, Participant 1 102 owes $10 million to Participant 2 104, while Participant 2 104 owes $10 million to Participant 3 106, and Participant 3 106 owes $10 million to Participant 1 102. Thus, each participant has bilateral net amounts of −$10 million and +$10 million and an aggregate net amount of $0. Thus, if the bilateral payments processor 126 requested only the aggregate net amount from each participant, no participants would provide any funding and the settlement process would be impossible to begin or complete, within the required parameters, such as assuring that no account has a balance less than zero at any time.

Such a circumstance is unlikely to arise in actual practice, but it illustrates why the funding calculator 406 of the bilateral payments processor 126 may request additional funding from each participant.

Another reason the funding calculator 406 of the bilateral payments processor 126 may request additional funding is in case one or more participants is late in providing funding. This risk may be mitigated if, for example, the funding calculator 406 adds an amount to each participant's requested funding equal to the largest payment the participant expects to receive. Then, even if the provider of that largest payment is late (and does not participate as expected) then the payments may still go forward, accounting for the exclusion of the late participant.

FIG. 6 illustrates an example of an environment in which five participants owe each other varying sums of money. Participant 1 102 expects to pay out 35 million, while receiving 33 million. Participant 2 104 expects to pay out 12 million, while receiving 36 million. Participant 3 106 expects to pay out 30 million, while receiving 25 million. Participant 4 expects to pay out 13 million, while receiving 10 million. And Participant 5 expects to pay out 29 million, while receiving 15 million.

Under the traditional funding model for a settlement agent, participant 1 would be asked to provide 35 million, participant 2 would provide 12 million, participant 3 would provide 30 million, participant 4 would provide 13 million, and participant 5 would provide 29 million. These values represent the total of all debts owed, regardless of expected income.

Under an optimized funding requirement, described above, in which each participant provides its net aggregate amount minus its largest expected received payment, participant 1 would provide 27 million, participant 2 would provide zero, participant 3 would provide 30 million, participant 4 would provide 13 million, and participant 5 would provide 29 million. This represents a significant funding savings for participants 1 and 2. Participants 3-5 see no benefit because they each only face a single counterparty from which they will receive a payment, so removing that payment results in them providing an amount similar to the traditional funding model. It should be noted that, in actual practice, most banks have many counterparts, and generally receive payments from more than one counterparty—thus seeing significantly more benefit from the described process in the form of lessened funding burden and thus, each financial organization would need take on less debt to fund its payment obligations for a given day.

### Device Environment

FIG. 7 is a block diagram of a general and/or special purpose computer 700, in accordance with some of the example embodiments of the invention. The computer 700 may be, for example, a user device, a user computer, a client computer and/or a server computer, among other things. The computer 700 may be located at the settlement agent 124.

The computer 700 may include without limitation a processor device 730, a main memory 735, and an interconnect bus 737. The processor device 730 may include without limitation a single microprocessor, or may include a plurality of microprocessors for configuring the computer 700 as a multi-processor system. The main memory 735 stores, among other things, instructions and/or data for execution by the processor device 730. The main memory 735 may include banks of dynamic random access memory (DRAM), as well as cache memory. The main memory 735 may contain instructions and/or data related to the bilateral payments processor 126, whose function is described above with relation to FIGS. 1-4, and such instructions may be executed by the processor device 730.

The computer 700 may further include a mass storage device 740, peripheral device(s) 742, portable non-transitory storage medium device(s) 746, input control device(s) 744, a graphics subsystem 748, and/or an output display 749. For explanatory purposes, all components in the computer 700 are shown in FIG. 7 as being coupled via the bus 737. However, the computer 700 is not so limited. Devices of the computer 700 may be coupled via one or more data transport means. For example, the processor device 730 and/or the main memory 735 may be coupled via a local microprocessor bus. The mass storage device 740, peripheral device(s) 742, portable storage medium device(s) 746, and/or graphics subsystem 748 may be coupled via one or more input/output (I/O) buses. The mass storage device 740 may be a non-volatile storage device for storing data and/or instructions for use by the processor device 730. The mass storage device 740 may be implemented, for example, with a magnetic disk drive or an optical disk drive. In a software embodiment, the mass storage device 740 is configured for loading contents of the mass storage device 740 into the main memory 735. The bilateral payments processor 126 may communicate with the mass storage device 740 to store information related to the operation of the bilateral payments processor including, but not limited to, storage of the ordered series of transactions, records of the instituted transactions, and logs related to sending and receiving messages from the concentration bank 122, concentration bank 222, and each participant 102-110.

The portable storage medium device 746 operates in conjunction with a nonvolatile portable storage medium, such as, for example, a compact disc read only memory (CD-ROM), to input and output data and code to and from the computer 700. In some embodiments, the software for storing information may be stored on a portable storage medium, and may be inputted into the computer 700 via the portable storage medium device 746. The peripheral device(s) 742 may include any type of computer support device, such as, for example, an input/output (I/O) interface configured to add additional functionality to the computer 700. For example, the peripheral device(s) 742 may include a network interface card for interfacing the computer 700 with a network 739. The bilateral payments processor 126 may communicate with the concentration bank 122 or concentration bank 222 to perform transfers between accounts through the network 739 or through other means.

The input control device(s) 744 provide a portion of the user interface for a user of the computer 700. The input control device(s) 744 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information related to the bilateral payments processor 126 or other processes, the computer 700 may include the graphics subsystem 748 and the output display 749. The output display 749 may include a cathode ray tube (CRT) display and/or a liquid crystal display (LCD). The graphics subsystem 748 receives textual and graphical information, and processes the information for output to the output display 749.

Each component of the computer 700 may represent a broad category of a computer component of a general and/or special purpose computer. Components of the computer 700 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CDROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field-programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer-readable media further include software for performing example aspects of the invention, as described above.

Included in the programming and/or software of the general and/or special purpose computer or microprocessor are software modules for implementing the procedures described above.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above-described example embodiments, but should be defined only in accordance with the following claims and their equivalents.

In addition, it should be understood that the FIGS. 1-7 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A computer implemented method of automatically performing bilateral payments among a plurality of participants via a network between a bilateral payments processor and each of the plurality of participant's computer system, comprising:
determining, for each participant, a bilateral net amount owed between that participant and each other participant, the bilateral net amount being the net value of cash flows to be paid or received between the participant and each other participant on a given day;
determining, for each participant, an aggregate net amount by summing all bilateral net amounts for the participant;
requesting each participant to provide an amount of money no less than the aggregate net amount owed by that participant to all other participants;
calculating an series of one or more bilateral transactions between each participant and each other participant that satisfies the bilateral net amount between each pair of participants, wherein at no time does the net amount paid by a participant to other participants minus the amount received by that participant from other participants exceed the amount provided by the participant, and wherein the series of one or more bilateral transactions are arranged to be performed in a predetermined order, thereby being a calculated ordered series of transactions; and
performing the calculated ordered series of transactions by transferring money between bank accounts wherein each transaction is separately recorded, timestamped and effected.

2. The method of claim 1 wherein the amount of money requested from one or more participants is less than the sum of the outstanding debts of the participant.

3. The method of claim 1 wherein the amount of money requested from each participant is equal to the participant's aggregate net amount minus the n largest, positive bilateral net amounts owed to that participant by one or more other participants, where n is an integer.

4. The method of claim 3 wherein n equals 1.

5. The method of claim 1 wherein the ordered series of transactions is calculated using a Monte Carlo simulation.

6. The method of claim 1 further wherein funding provided by each participant is contained in a concentration account for that participant.

7. The method of claim 6 further comprising transferring the provided funds from a settlement account.

8. The method of claim 7 further comprising transferring funds from the concentration account to the settlement account after performing the ordered series of transactions.

9. A system for automatically performing bilateral payments among a plurality of participants via a network between a bilateral payments processor and each of the plurality of participant's computer system, comprising:
a computer-readable memory storing executable instructions; and
one or more processors in communication with the computer-readable memory, wherein the one or more processors are programmed by the executable instructions to at least perform:
determining, for each participant, a bilateral net amount owed between that participant and each other participant, the bilateral net amount being the net value of cash flows to be paid or received between the participant and each other participant on a given day;
determining, for each participant, an aggregate net amount by summing all bilateral net amounts for the participant;
requesting each participant to provide an amount of money no less than the aggregate net amount owed by that participant to all other participants;
calculating an series of one or more bilateral transactions between each participant and each other participant that satisfies the bilateral net amount between each pair of participants, wherein at no time does the net amount paid by a participant to other participants minus the amount received by that participant from other participants exceed the amount provided by the participant, and wherein the series of one or more bilateral transactions are arranged to be performed in a predetermined order, thereby being a calculated ordered series of transactions; and
performing the calculated ordered series of transactions by transferring money between bank accounts wherein each transaction is separately recorded, timestamped and effected.

10. The system of claim 9 wherein the amount of money requested from one or more participants is less than the sum of the outstanding debts of the participant.

11. The system of claim 9 wherein the amount of money requested from each participant is equal to the participant's aggregate net amount minus the n largest, positive bilateral net amounts owed to that participant by one or more other participants, where n is an integer.

12. The system of claim 10 wherein n equals 1.

13. The system of claim 9 wherein the ordered series of transactions is calculated using a Monte Carlo simulation.

14. The system of claim 9 further wherein funding provided by each participant is contained in a concentration account for that participant.

15. The system of claim 14 further comprising transferring the provided funds from a settlement account.

16. The system of claim 15 further comprising transferring funds from the concentration account to the settlement account after performing the ordered series of transactions.

17. A non-transitory computer-readable medium having stored thereon one or more sequences of instructions, which when executed by one or more processors, cause the one or more processors to perform:
determining, for each participant, a bilateral net amount owed between that participant and each other participant, the bilateral net amount being the net value of cash flows to be paid or received between the participant and each other participant on a given day;
determining, for each participant, an aggregate net amount by summing all bilateral net amounts for the participant;
requesting each participant to provide an amount of money no less than the aggregate net amount owed by that participant to all other participants;
calculating an series of one or more bilateral transactions between each participant and each other participant that satisfies the bilateral net amount between each pair of participants, wherein at no time does the net amount paid by a participant to other participants minus the amount received by that participant from other participants exceed the amount provided by the participant, and wherein the series of one or more bilateral transactions are arranged to be performed in a predetermined order, thereby being a calculated ordered series of transactions; and
performing the calculated ordered series of transactions by transferring money between bank accounts wherein each transaction is separately recorded, timestamped and effected.

18. The non-transitory computer-readable medium of claim 17, wherein the amount of money requested from one or more participants is less than the sum of the outstanding debts of the participant.

19. The non-transitory computer-readable medium of claim 17, wherein the amount of money requested from each participant is equal to the participant's aggregate net amount minus the n largest, positive bilateral net amounts owed to that participant by one or more other participants, where n is an integer.

20. The non-transitory, computer-readable medium of claim 19, wherein n equals 1.

21. The non-transitory computer-readable medium of claim 17, wherein the ordered series of transactions is calculated using a Monte Carlo simulation.

22. The non-transitory computer-readable medium of claim 17, further wherein funding provided by each participant is contained in a concentration account for that participant.

23. The non-transitory computer-readable medium of claim 22 further comprising transferring the provided funds from a settlement account.

24. The non-transitory computer-readable medium of claim 23 further comprising transferring funds from the concentration account to the settlement account after performing the ordered series of transactions.
